(19) United States
(12) Patent Application Publication
(10) Pub. No.: US 2017/0108058 A1
(43) Pub. Date: Apr. 20, 2017

(54) Easily Replaceable One-Way Transmission Module

(71) Applicant: Fu Sheng Chen, TAICHUNG (TW)

(72) Inventor: Fu Sheng Chen, TAICHUNG (TW)

(21) Appl. No.: 14/886,072

(22) Filed: Oct. 18, 2015

(51) Int. Cl. F16D 41/066; F16D 41/28

(52) U.S. Cl. CPC F16D 41/066; F16D 41/28; F16D 2041/0605

(57) ABSTRACT

A one-way transmission module includes an external ring, an internal ring and catch units. The external ring includes a non-circular external face for engagement with an internal face of a hub or a flywheel-bearing drum. The internal ring includes a non-circular internal face for engagement with an external face of the drum or the hub. An external face of the internal ring includes planar facets each comprising two terminal portions and a middle portion located further from the internal face of the external ring than the terminal portions. Each catch unit is arranged between the internal face of the external ring and a corresponding of the planar facets of the internal ring to allow the external and internal rings to rotate together in a forward direction but not allow the external and internal rings to rotate together in a backward direction.

### BACKGROUND OF INVENTION

1. Field of Invention

The present invention relates to a bicycle and, more particularly, to an easily replaceable one-way transmission module arranged between a hub and a flywheel cassette.

2. Related Prior Art

A typical bicycle includes a frame, a fork rotationally connected to a front portion of the frame, a front wheel rotationally connected to the fork, a rear wheel rotationally connected to a rear portion of the frame, at least one sprocket rotationally connected to a middle portion of the frame, two cranks operatively connected to the sprocket, at least one flywheel connected to the rear wheel, and a chain for operatively connecting the flywheel to the sprocket. The rear wheel includes a rim, a hub and spokes for connecting the rim to the hub. A one-way transmission mechanism is arranged between the hub and the flywheel cassette. Thus, the flywheel cassette rotates the hub in a forward direction, but the hub does not rotate the flywheel cassette in the forward direction.

As disclosed in Taiwanese Patent I423899, a conventional hub assembly includes a hub 20 and a drum 21. The drum 21 is used to support a flywheel cassette 80. The hub assembly is assembled in a way that a one-way transmission mechanism (not shown) arranged between the hub 20 and the drum 21 cannot be removed for repair or replacement with a new one.

As disclosed in Taiwanese Patent M314697, another conventional hub assembly includes a hub 20, a drum 40 and a one-way transmission mechanism between them. The drum 40 is used to support a flywheel cassette. The one-way transmission mechanism includes a ring 24 fitted in an opening 23 made in the hub 20, a ring 41 formed on the drum 40, and catches or pawls 42 arranged between the ring 41 and the ring 24. Each catch 42 includes a sharp end and an obtuse end. The ring 41 includes a plurality of recesses each for receiving the obtuse end of a corresponding catch 42 so that the catches 42 can pivot relative to the ring 41. A C-clip is used to keep the catches 42 on the ring 41. The ring 24 is formed with teeth for engagement with the sharp ends of the catches 42. The ring 41 is inserted in the ring 24. When the ring 41 rotates in a first direction, the sharp ends of the catches 42 engage with some of the teeth of the ring 42 so that the ring 41 rotates the ring 24 in the first direction. As the ring 24 stops or rotates in a second direction, the sharp ends of the catches 42 rattle and slide on the teeth of the ring 42 to allow the ring 24 to rotate in the first direction relative to the ring 41. Inevitably, the teeth of the ring 24 and the catches 42 wear away against each other. In such a case, the ring 24 and the catches 42 should be removed from the hub 20 and replaced with new ones. However, it is very difficult to remove the ring 24 from the hub 20. In fact, it is almost impossible to remove the ring 24 from the hub 20 without causing damage to the hub 20. Therefore, in practice, the entire hub assembly is replaced with a new hub assembly when only the ring 24 and the catches 42 are worn out.

As disclosed in co-pending U.S. patent application Ser. No. 14/661,316, a one-way transmission module includes two rings and at least one catch. The first ring is used for connection to a hub. The second ring is used for connection to a flywheel-bearing drum. The catch is arranged between the first and second rings to allow the first ring to rotate the second ring in a first direction but prevent the first ring from rotating the second ring in a second direction opposite to the first direction. The first or second ring includes a non-circular profile while the second or first ring includes a non-circular opening.

The present invention is therefore intended to obviate or alleviate the problems encountered in prior art.

### SUMMARY OF INVENTION

It is the primary objective of the present invention to provide a one-way transmission module that can easily be arranged between a hub and a flywheel cassette and removed from the hub and the flywheel cassette.

To achieve the foregoing objectives, the one-way transmission module includes an external ring, an internal ring and catch units. The external ring includes a non-circular external face for engagement with an internal face of a hub or a flywheel-bearing drum. The internal ring includes a non-circular internal face for engagement with an external face of the drum or the hub. An external face of the internal ring includes planar facets each comprising two terminal portions and a middle portion located further from the internal face of the external ring than the terminal portions. Each catch unit is arranged between the internal face of the external ring and a corresponding of the planar facets of the internal ring to allow the external and internal rings to rotate together in a forward direction but not allow the external and internal rings to rotate together in a backward direction.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a one-way transmission module according to the preferred embodiment of the present invention;

FIG. 2 is a perspective view of an elastic element used in the one-way transmission module shown in FIG. 1;

FIG. 3 is a side view of the one-way transmission module shown in FIG. 1, with an annular seal removed;

FIG. 4 is a cross-sectional view of the one-way transmission module shown in FIG. 1;

FIG. 5 is a partial view of the one-way transmission module shown in FIG. 4, with a annular seal removed; and

FIG. 6 is an exploded view of a hub assembly including the one-way transmission module shown in FIG. 1.

### DETAILED DESCRIPTION OF PREFERRED EMBODIMENT

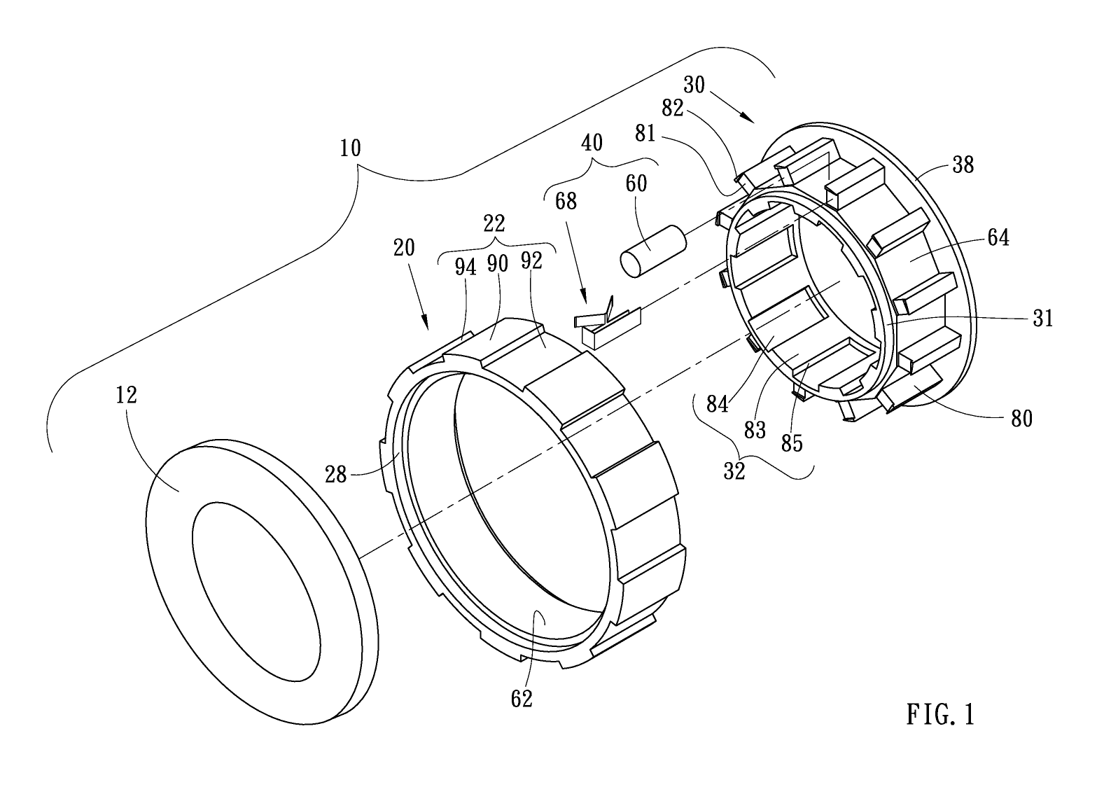

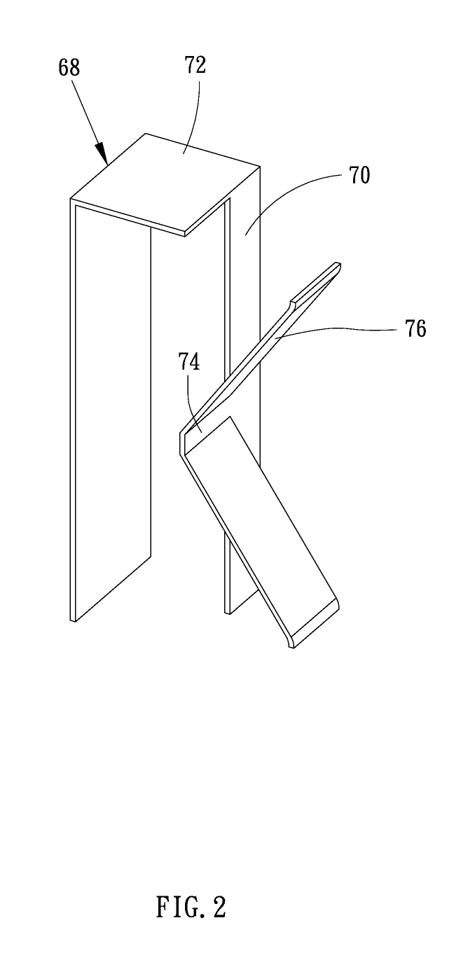

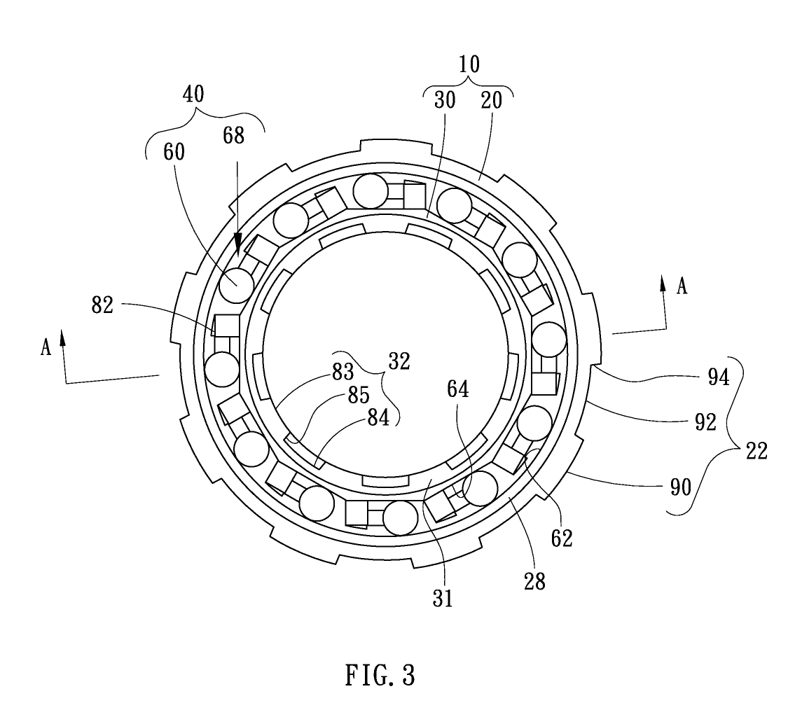

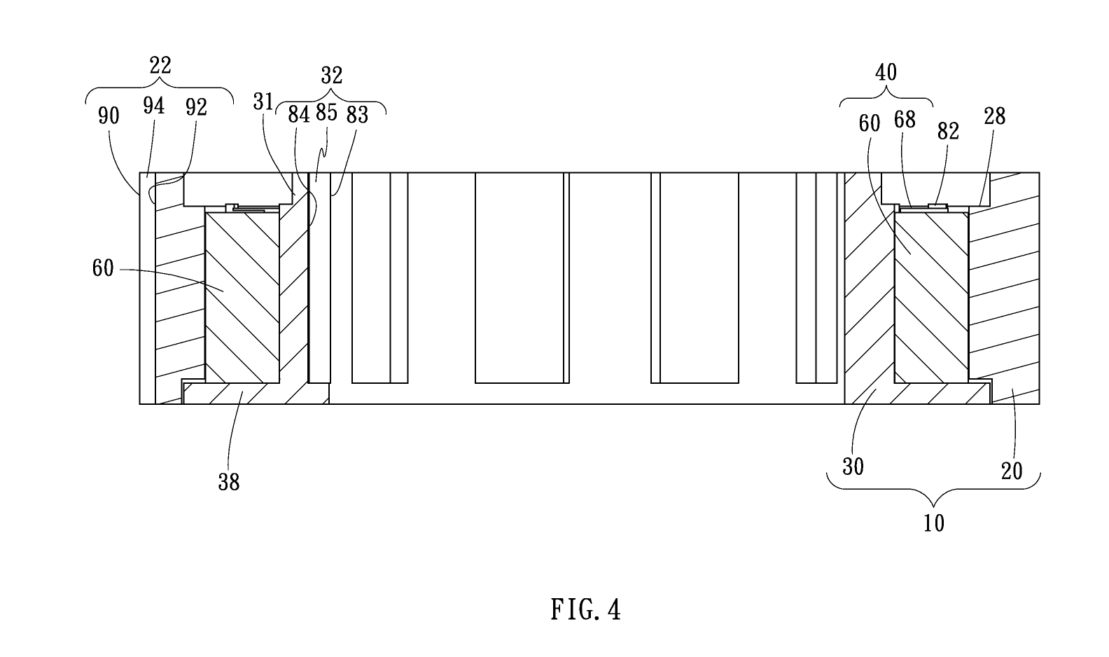

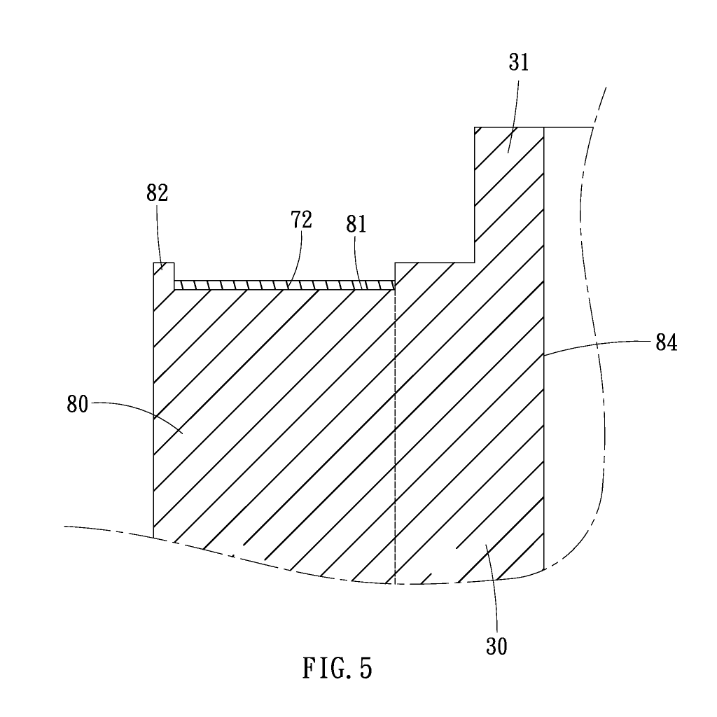

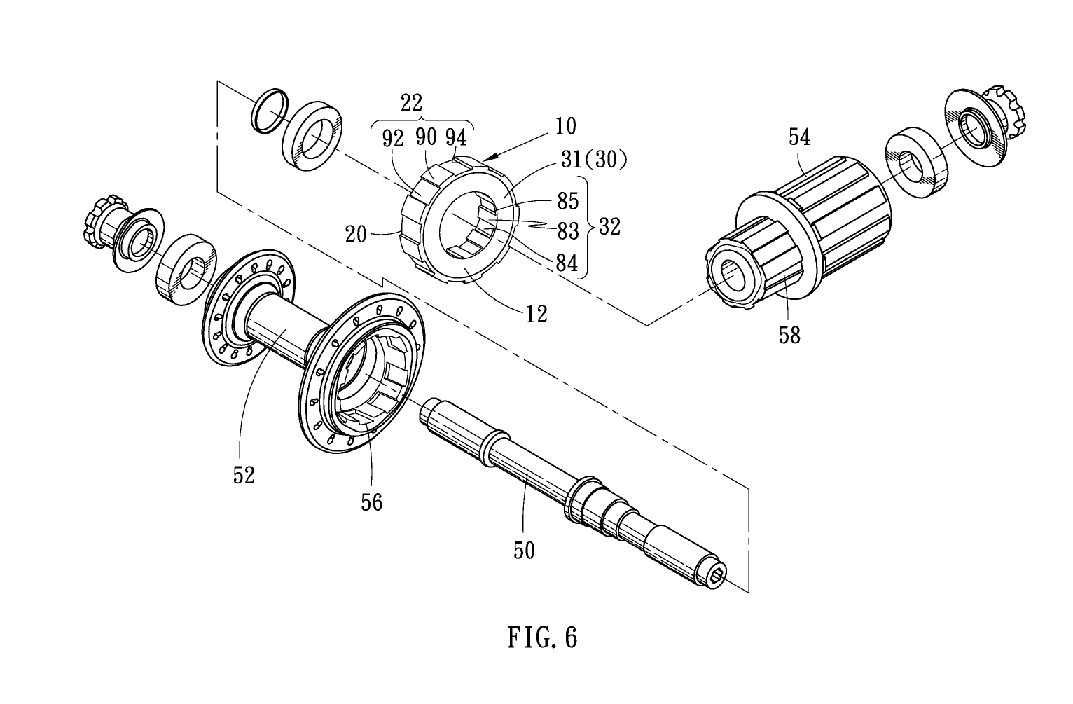

Referring to FIGS. 1 through 5, a one-way transmission module 10 includes an annular seal 12, an external ring 20, an internal ring 30 and a plurality of catch units 40 according to the preferred embodiment of the present invention. The one-way transmission module 10 is for use in a hub assembly shown in FIG. 6.

The external ring 20 includes an external face 22, an internal face 62 and two openings 28. The external face 22 includes a plurality of splines 90, a plurality of recesses 92 and a plurality of shoulders 94. Each shoulder 94 is formed between an adjacent spline 90 and an adjacent recess 92. The external face 22 is not a smooth circular face but looks like a toothed face of a gear. The internal face 62 is located between the openings 28. The diameter of the internal face 62 is smaller than that of the openings 28.

The internal ring 30 includes a reduced portion 31, an annular flange 38, an internal face 32 and an external face (not numbered). The reduced portion 31 axially extends from an end of the internal ring 30. The annular flange 38 extends around another end of the internal ring 30.

The internal face 32 includes a plurality of ribs 83, a plurality of recesses 84, and a plurality of shoulders 85. Each shoulder 85 is formed between an adjacent rib 83 and an adjacent recess 84. The internal face 32 is not a smooth circular face but looks like a toothed face of a gear.

The external face of the internal ring 30 includes a plurality of planar facets 64 and a plurality of ribs 80. The planar facets 64 and the ribs 80 are alternately arranged. Each planar facet 64 includes a middle portion between two terminal portions each in the vicinity of an adjacent rib 80. The ribs 80 and the internal ring 30 are made in one piece. Each of the ribs 80 includes a flat end 81 and a nail-shaped portion 82 longitudinally extending from the flat end 81.

Each catch unit 40 includes a roller 60 and an elastic element 68. The roller 60 is in the form of a circular rod. The elastic element 68 includes two lateral strips 70, a connective strip 72, two elastic strips 76 and an interconnecting strip 74. One of the lateral strips 70 (the “small lateral strip 70”) is made smaller than the other lateral strip 70 (the “large lateral strip 70”) although they are given a same reference number. The lateral strips 70 are connected to each other by the connective strip 72 so that three of them form a U-shaped element. The elastic strips 76 are interconnected by the interconnecting strip 74 that extends from an edge of the small lateral strip 70. The elastic strips 76 do not extend in a same plane.

The internal ring 30 is coaxially inserted in the external ring 20. The planar facets 64 face the internal face 62. The middle portion of each planar facet 64 is located further from the internal face 62 than the terminal portions of the same planar facet 64. The annular seal 12 and the annular flange 38 are respectively inserted in the openings 28 of the external ring 20. The reduced portion 31 of the internal ring 30 is inserted in the annular seal 12.

The catch units 40 are located between the external ring 20 and the internal ring 30 before the internal ring 30 is coaxially inserted in the external ring 20. The catch units 40 enable the internal ring 30 to rotate the external ring 20 in a forward direction, not in a backward direction.

The following description will be given to only an exemplary one of the catch units 40. The roller 60 is located between two corresponding ribs 80, in contact with a corresponding planar facet 64. The roller 60 is allowed to roll on the corresponding planar facet 64 between the corresponding ribs 80. The lateral strips 70 of the elastic element 68 clips a corresponding rib 80 while the connective strip 72 of the elastic element 68 rests on the flat end 81 of the corresponding rib 80. The elastic element 68 is kept in position by the nail-shaped portion 82 of the corresponding rib 80. The elastic strips 76 of the elastic element 68 are in contact with the roller 60. Thus, the elastic element 68 biases the roller toward one of the terminal portions of the corresponding planar facet 64.

The terminal portion of the corresponding planar facet 64 pushes the roller 60 against the internal face 62 while the internal ring 30 is rotated in the forward direction. Thus, the internal ring 30 rotates the external ring 20 in the forward direction.

The elastic element 68 allows the roller 60 to move toward the middle portion of the corresponding planar facet 64 while the internal ring 30 is rotated in the backward direction. The middle portion of the corresponding planar facet 64 does not push the roller 60 against the internal face 62. Thus, the internal ring 30 does not rotate the external ring 20 in the backward direction.

In operation, the roller 60 rolls smoothly since it is biased by the elastic element 68. Hence, the roller 60 does not fiercely hit the internal face 62 of the external ring 20. Accordingly, the catch unit 40 does not make click sounds. Therefore, the operation of the catch unit 40 is smooth and quiet.

Referring to FIG. 6, the hub assembly includes a hollow shaft 50, a hub 52 and a drum 54. Preferably, the hub 52 includes a plurality of recesses 56 corresponding to the splines 90 of the external ring 20 of the one-way transmission module 10. The drum 54 includes, on a reduced portion, a plurality of splines 58 corresponding to the recesses 84 of the internal ring 30 of the one-way transmission module 10.

The one-way transmission module 10 is arranged between the hub 52 and the drum 54. The splines 90 of the external ring 20 of the one-way transmission module 10 are inserted in the recesses 56 of the hub 52. The splines 58 of the drum 54 are inserted in the recesses 84 of the internal ring 30 of the one-way transmission module 10. The hollow shaft 50 is inserted in the hub 52 and the drum 54 and the one-way transmission module 10. The hub 52 is connected to a rim of a wheel (not shown) by spokes (not shown). The drum 54 is inserted in and connected to a flywheel cassette (not shown). A quick-release skew (not shown) is inserted in the hollow shaft 50. The hub assembly is supported on a frame of a bicycle frame by the quick-release skew. The sprocket set is connected to a crank set (not shown) by a chain (not shown). While the crank set and the flywheel cassette are rotated in the forward direction, the drum 54 accordingly rotates the hub 52 via the one-way transmission module 10. Hence, the wheel is rotated in the forward direction. When the crank set and the flywheel cassette are rotated in the backward direction, the drum 54 does not rotate the hub 52 because of the one-way transmission module 10. Hence, the wheel is not rotated in the backward direction.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A one-way transmission module comprising:
an external ring comprising:
an internal face; and
a non-circular external face for engagement with an internal face of one of a hub and a flywheel-bearing drum; and
an internal ring comprising:
an external face comprising planar facets each comprising two terminal portions and a middle portion located further from the internal face of the external ring than the terminal portions; and
a non-circular internal face for engagement with an external face of the other of the hub and the drum; and
a plurality of catch units each arranged between the internal face of the external ring and a corresponding of the planar facets of the internal ring to allow the external and internal rings to rotate together in a forward direction but not allow the external and internal rings to rotate together in a backward direction.

2. The one-way transmission module according to claim 1, wherein the non-circular external face of the external ring is adapted for engagement with the internal face of the hub while the non-circular internal face of the internal ring is adapted for engagement with the external face of the drum.

3. The one-way transmission module according to claim 2, wherein the catch units are arranged between the external and internal rings to allow the internal ring to rotate the external ring in the forward direction but not allow the internal ring to rotate the external ring in the backward direction.

4. The one-way transmission module according to claim 3, wherein the internal face of the external ring is a circular face.

5. The one-way transmission module according to claim 4, wherein the external face of the internal ring further comprises a plurality of ribs alternatively arranged with the planar facets.

6. The one-way transmission module according to claim 5, wherein each of the catch unit comprises:
a roller movable on a corresponding one of the planar facets between two corresponding ones of the ribs; and
an elastic element for biasing the roller away from the middle portion of the corresponding planar facet against a corresponding one of the ribs, wherein the roller is jammed between the corresponding planar facet of the internal ring and the internal face of the external ring when the internal ring rotates in the forward direction, wherein the roller is allowed to return to the middle portion of the corresponding planar facet and hence not jammed between the corresponding planar facet of the internal ring and the internal face of the external ring when the internal ring rotates in the backward direction.

7. The one-way transmission module according to claim 6, wherein the elastic element comprises two lateral strips for clipping the corresponding rib.

8. The one-way transmission module according to claim 7, wherein the elastic element comprises two elastic strips extending from one of the lateral strips into contact with the roller.

9. The one-way transmission module according to claim 8, wherein the elastic element comprises a connective strip formed between the lateral strips, wherein each of the ribs comprises a flat end for supporting the connective strip.

10. The one-way transmission module according to claim 9, wherein each of the ribs comprises a nail-shaped portion formed at the flat end and operable to contact the connective strip to keep the elastic element on the corresponding rib.

11. The one-way transmission module according to claim 1, further comprising an annular seal connected to the external ring.

12. The one-way transmission module according to claim 11, wherein the external ring comprises an opening for receiving the annular seal.

13. The one-way transmission module according to claim 11, wherein the internal ring comprises a reduced portion inserted in the annular seal.

14. The one-way transmission module according to claim 1, wherein the internal ring comprises an annular flange connected to the external ring opposite to the annular seal.

15. The one-way transmission module according to claim 14, wherein the external ring comprises an opening for receiving the annular flange.

16. The one-way transmission module according to claim 1, wherein the external ring comprising splines formed on the external face and recesses alternatively arranged with the splines.

17. The one-way transmission module according to claim 1, wherein the internal ring comprises ribs formed on the internal face and recesses alternatively arranged with the ribs.
